(19) United States
(12) Patent Application Publication
(10) Pub. No.: US 2020/0023992 A1
(43) Pub. Date: Jan. 23, 2020

(54) NETWORK FOR MANAGING AN AIRCRAFT MINIMUM EQUIPMENT LIST

(71) Applicant: HONEYWELL INTERNATIONAL INC., Morris, NJ (US)

(72) Inventors: Cody Ryan Conaway, Phoenix, AZ (US); Nalamalpu Aneel Kumar Reddy, Hyderabad (IN); Chandrasekhar Aleti, Hyderabad (IN); Aaron Gannon, Anthem, AZ (US); Barbara Holder, Seattle, WA (US); Jason Bialek, Arlington, WA (US)

(73) Assignee: HONEYWELL INTERNATIONAL INC., Morris Plains, NJ (US)

(21) Appl. No.: 16/358,815

(22) Filed: Mar. 20, 2019

(30) Foreign Application Priority Data
Jul. 17, 2018 (IN) 201841026726

(51) Int. Cl. B64D 45/00; B64F 5/60

(52) U.S. Cl. CPC B64D 45/00; B64D 2045/0085; B64F 5/60

(57) ABSTRACT

Methods and systems are provided for managing a minimum equipment list (MEL) for an aircraft. The method comprises first generating a MEL that is specific to the aircraft. Next, the performance parameters of the aircraft are monitored. MEL faults are detected by continually comparing the performance to the MEL during operations of the aircraft. A MEL network is notified of the detected MEL faults. The MEL network includes parties affected by the detected MEL faults.

### CROSS-REFERENCE TO RELATED APPLICATION(S)

This application claims the priority benefit of Indian Provisional Patent Application No. 201841026726, titled “A NETWORK FOR MANAGING AN AIRCRAFT MINIMUM EQUIPMENT LIST” that was filed Jul. 17, 2018.

### TECHNICAL FIELD

The present invention generally relates to aircraft operations, and more particularly relates to a network for managing an aircraft minimum equipment list.

### BACKGROUND

A Minimum Equipment List (MEL) for an aircraft is a document which pilots use to obtain relief from the Federal Aviation Regulation (FAR) that require all installed equipment onboard an aircraft be operative at the time of flight. It allows crews to safely dispatch or continue a flight with certain inoperative equipment. It is aircraft-specific and lists which items may be inoperative, along with any procedures that must be modified to maintain airworthiness. Hence, there is a need for a network for managing an aircraft MEL.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

A method is provided for managing a minimum equipment list (MEL) for an aircraft. The method comprises: generating a MEL that is specific to the aircraft; monitoring performance parameters of the aircraft; comparing the performance parameters to the MEL to detect MEL faults, where the performance parameters are continually compared to the MEL during operations of the aircraft; and notifying a MEL network of the detected MEL faults, where the MEL network comprises parties affected by the detected MEL faults.

A system is provided for managing a minimum equipment list (MEL) for an aircraft. The system comprises: a flight management system (FMS) located on board the aircraft; a master minimum equipment list (MMEL) that is provided by an original equipment manufacturer (OEM) of the aircraft, where the MMEL is transmitted to the FMS via a data communications link; and a minimum equipment list (MEL) application loaded on the FMS, where the MEL application, generates a MEL based on the MMEL that is specific to the aircraft; monitors performance parameters of the aircraft; compares the performance parameters to the MEL to detect MEL faults, where the performance parameters are continually compared to the MEL during operations of the aircraft; and notifies a MEL network of the detected MEL faults, where the MEL network comprises parties affected by the detected MEL faults.

Furthermore, other desirable features and characteristics of the method and system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIG. 1 shows a diagram of aircraft computer system in accordance with disclosed embodiments;

FIG. 2 shows an onboard flight management computer system for in accordance with disclosed embodiments;

FIG. 3 shows a block diagram of a flight management system (FMS) on board an aircraft in accordance with disclosed embodiments;

FIG. 4 shows a block diagram of the functioning of an MEL network in accordance with disclosed embodiments; and

FIG. 5 shows a flow chart of a method of managing an MEL network for an aircraft in accordance with disclosed embodiments.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

A network for managing an aircraft MEL has been developed. The MEL provides real-time aircraft status to crews, maintenance, operations/dispatch centers, and customers with respect to inoperative equipment. The intended function of the MEL network is to provide a proactive, shared awareness of aircraft (fleet) status and off-nominal operational impact, while enhancing decision making efficiency, and reducing decision making error with respect to dispatch and continued airworthiness. The status includes the operational impact and consequences caused by MEL faults. Users derive the MEL from a certified Master Minimum Equipment List (MMEL) that is provided by the Original Equipment Manufacturer (OEM).

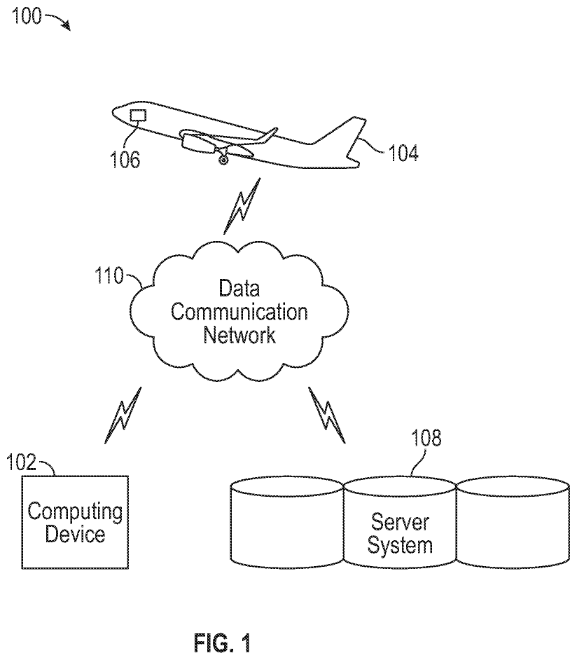

Turning now to the figures, FIG. 1 is a diagram of aircraft computer system 100, in accordance with the disclosed embodiments. The disclosed computer system 100 includes a computing device 102, one or more avionics systems 106, a server system 108, and a data communication network 110, some or all of which may be disposed in an aircraft 104. The computing device 102 may be implemented by any computing device that includes at least one processor, some form of memory hardware, a user interface, and communication hardware. For example, the computing device 102 may be implemented using a personal computing device, such as a tablet computer, a laptop computer, a personal digital assistant (PDA), a smartphone, or the like. In this scenario, the computing device 102 is capable of storing, maintaining, and executing Electronic Flight Bag (EFB) applications. In other embodiments, the computing device 102 may be implemented using a computer system onboard the aircraft 104 such as a flight management computing module (FMC).

The aircraft 104 may be implemented as an airplane, helicopter, spacecraft, hovercraft, or the like. The one or more avionics systems 106 may include a Flight Management System (FMS), navigation devices, weather detection devices, radar devices, communication devices, brake systems, and/or any other electronic system or avionics system used to operate the aircraft 104. Data obtained from the one or more avionics systems 106 may include, without limitation: flight data, aircraft heading, aircraft speed, aircraft position, altitude, descent rate, position of air spaces surrounding a current flight plan, activity of air spaces surrounding a current flight plan, or the like.

The server system 108 may include any number of application servers, and each server may be implemented using any suitable computer. In some embodiments, the server system 108 includes one or more dedicated computers. In some embodiments, the server system 108 includes one or more computers carrying out other functionality in addition to server operations. The server system 108 may store and provide any type of data. Such data may include, without limitation: flight plan data, aircraft parameters, avionics data and associated user actions, and other data compatible with the computing device 102.

The computing device 102 is usually located onboard the aircraft 104, and the computing device 102 communicates with the one or more avionics systems 106 via wired and/or wireless communication connection. The computing device 102 and the server system 108 may both be located onboard the aircraft 104. In other embodiments, the computing device 102 and the server system 108 may be disparately located, and the computing device 102 communicates with the server system 108 via the data communication network 110 and/or via communication mechanisms onboard the aircraft 104.

The data communication network 110 may be any digital or other communications network capable of transmitting messages or data between devices, systems, or components. In certain embodiments, the data communication network 110 includes a packet switched network that facilitates packet-based data communication, addressing, and data routing. The packet switched network could be, for example, a wide area network, the Internet, or the like. In various embodiments, the data communication network 110 includes any number of public or private data connections, links or network connections supporting any number of communications protocols. The data communication network 110 may include the Internet, for example, or any other network based upon TCP/IP or other conventional protocols. In various embodiments, the data communication network 110 could also incorporate a wireless and/or wired telephone network, such as a cellular communications network for communicating with mobile phones, personal digital assistants, and/or the like. The data communication network 110 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol. For the sake of brevity, conventional techniques related to data transmission, signaling, network control, and other functional aspects of the systems (and the individual operating components of the systems) may not be described in detail herein.

Embodiments of the subject matter described herein relate to an existing module integrated, incorporated, or otherwise instantiated for interoperability and use with other existing components of a vehicle system. For purposes of explanation, the subject matter is described herein primarily in the context of aircraft, however, the subject matter is not necessarily limited to use with aircraft and may be implemented in an equivalent manner for other types vehicles (e.g., automotive vehicles, marine vessels, or the like).

In exemplary embodiments, an existing flight management computer (FMC) (or flight management system (FMS)) onboard an aircraft is utilized to communicate data between existing onboard avionics systems or line-replaceable units (LRUs) and another module coupled to the FMC, which supports or otherwise performs flight management functionality that is not performed by the FMC. For example, a multifunction control and display unit (MCDU) may support or otherwise perform flight management functionality based on data from onboard avionics or LRUs received via the FMC. In this regard, the FMC may be configured to receive operational or status data from one or more avionics systems or LRUs onboard the aircraft at corresponding avionics interfaces and convert one or more characteristics of the operational data to support communicating the operational data with the MCDU.

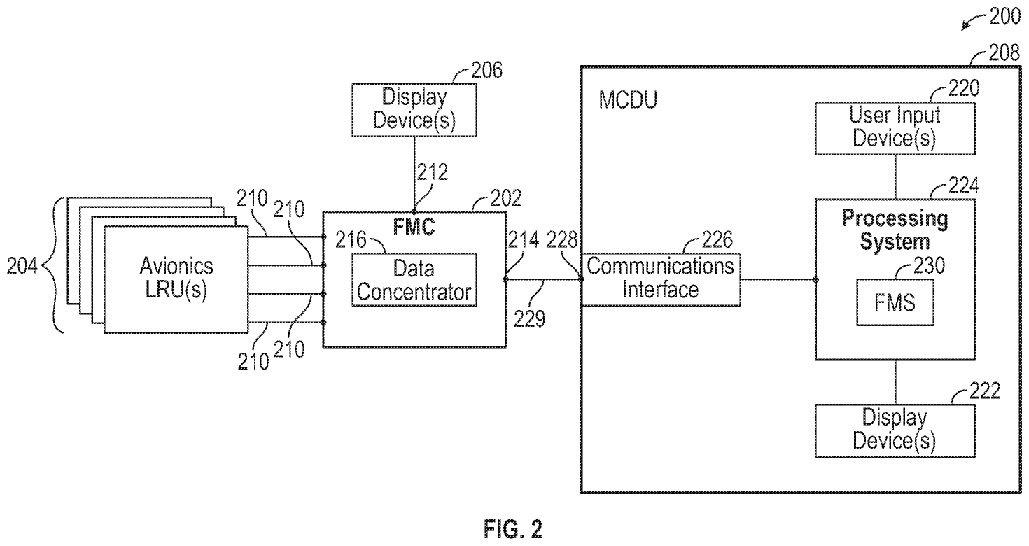

FIG. 2 depicts an exemplary embodiment of an aircraft system 200 suitable for implementation onboard an aircraft. The illustrated aircraft system 200 includes a flight management computing module 202 communicatively coupled to a plurality of onboard avionics LRUs 204, one or more display devices 206, and a multifunction computing module 208. It should be appreciated that FIG. 2 depicts a simplified representation of the aircraft system 200 for purposes of explanation, and FIG. 2 is not intended to limit the subject matter in any way.

The flight management computing module 202 generally represents the FMC, the FMS, or other hardware, circuitry, logic, firmware and/or other components installed onboard the aircraft and configured to perform various tasks, functions and/or operations pertaining to flight management, flight planning, flight guidance, flight envelope protection, four-dimensional trajectory generation or required time of arrival (RTA) management, and the like. The FMC module 202 depicted here, is a detailed embodiment of the computing device shown previously in FIG. 1. Accordingly, for purposes of explanation, but without limiting the functionality performed by or supported at the flight management computing module 202, the flight management computing module 202 may alternatively be referred to herein as the FMC. The FMC 202 includes a plurality of interfaces 210 configured to support communications with the avionics LRUs 204 along with one or more display interfaces 212 configured to support coupling one or more display devices 206 to the FMC 202. In the illustrated embodiment, the FMC 202 also includes a communications interface 214 that supports coupling the multifunction computing module 208 to the FMC 202.

The FMC 202 generally includes a processing system designed to perform flight management functions, and potentially other functions pertaining to flight planning, flight guidance, flight envelope protection, and the like. Depending on the embodiment, the processing system could be realized as or otherwise include one or more processors, controllers, application specific integrated circuits, programmable logic devices, discrete gate or transistor logics, discrete hardware components, or any combination thereof. The processing system of the FMC 202 generally includes or otherwise accesses a data storage element (or memory), which may be realized as any sort of non-transitory short or long term storage media capable of storing programming instructions for execution by the processing system of the FMC 202. In exemplary embodiments, the data storage element stores or otherwise maintains code or other computer-executable programming instructions that, when read and executed by the processing system of the FMC 202, cause the FMC 202 to implement, generate, or otherwise support a data concentrator application 216 that performs certain tasks, operations, functions, and processes described herein.

The avionics LRUs 204 generally represent the electronic components or modules installed onboard the aircraft that support navigation, flight planning, and other aircraft control functions in a conventional manner and/or provide real-time data and/or information regarding the operational status of the aircraft to the FMC 202. For example, practical embodiments of the aircraft system 200 will likely include one or more of the following avionics LRUs 204 suitably configured to support operation of the aircraft: a weather system, an air traffic management system, a radar system, a traffic avoidance system, an autopilot system, an autothrottle (or autothrust) system, a flight control system, hydraulics systems, pneumatics systems, environmental systems, electrical systems, engine systems, trim systems, lighting systems, crew alerting systems, electronic checklist systems, and/or another suitable avionics system.

In exemplary embodiments, the avionics interfaces 210 are realized as different ports, terminals, channels, connectors, or the like associated with the FMC 202 that are connected to different avionics LRUs 204 via different wiring, cabling, buses, or the like. In this regard, the interfaces 210 may be configured to support different communications protocols or different data formats corresponding to the respective type of avionics LRU 204 that is connected to a particular interface 210. For example, the FMC 202 may communicate navigation data from a navigation system via a navigation interface 210 coupled to a data bus supporting the ARINC 424 (or A424) standard, the ARINC 629 (or A629) standard, the ARINC 422 (or A422) standard, or the like. As another example, a datalink system or other communications LRU 204 may utilize an ARINC 619 (or A619) compatible avionics bus interface for communicating datalink communications or other communications data with the FMC 202.

The display device(s) 206 generally represent the electronic displays installed onboard the aircraft in the cockpit, and depending on the embodiment, could be realized as one or more monitors, screens, liquid crystal displays (LCDs), a light emitting diode (LED) displays, or any other suitable electronic display(s) capable of graphically displaying data and/or information provided by the FMC 202 via the display interface(s) 212. Similar to the avionics interfaces 210, the display interfaces 212 are realized as different ports, terminals, channels, connectors, or the like associated with the FMC 202 that are connected to different cockpit displays 206 via corresponding wiring, cabling, buses, or the like. In one or more embodiments, the display interfaces 212 are configured to support communications in accordance with the ARINC 661 (or A661) standard. In one embodiment, the FMC 202 communicates with a lateral map display device 206 using the ARINC 702 (or A702) standard.

In exemplary embodiments, the multifunction computing module 208 is realized as a multifunction control and display unit (MCDU) that includes one or more user interfaces, such as one or more input devices 220 and/or one or more display devices 222, a processing system 224, and a communications module 226. The MCDU 208 generally includes at least one user input device 220 that is coupled to the processing system 224 and capable of receiving inputs from a user, such as, for example, a keyboard, a key pad, a mouse, a joystick, a directional pad, a touchscreen, a touch panel, a motion sensor, or any other suitable user input device or combinations thereof. The display device(s) 222 may be realized as any sort of monitor, screen, LCD, LED display, or other suitable electronic display capable of graphically displaying data and/or information under control of the processing system 224.

The processing system 224 generally represents the hardware, circuitry, logic, firmware and/or other components of the MCDU 208 configured to perform the various tasks, operations, functions and/or operations described herein. Depending on the embodiment, the processing system 224 may be implemented or realized with a general purpose processor, a microprocessor, a controller, a microcontroller, a state machine, an application specific integrated circuit, a field programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by the processing system 224, or in any practical combination thereof. In this regard, the processing system 224 includes or accesses a data storage element (or memory), which may be realized using any sort of non-transitory short or long term storage media, and which is capable of storing code or other programming instructions for execution by the processing system 224. In exemplary embodiments described herein, the code or other computer-executable programming instructions, when read and executed by the processing system 224, cause the processing system 224 to implement or otherwise generate a flight management system application 230 and perform additional tasks, operations, functions, and processes described herein.

The communications module 226 generally represents the hardware, module, circuitry, software, firmware and/or combination thereof that is coupled between the processing system 224 and a communications interface 228 of the MCDU 208 and configured to support communications between the MCDU 208 and the FMC 202 via an electrical connection 229 between the MCDU communications interface 228 and the FMC communications interface 214. For example, in one embodiment, the communications module 226 is realized as an Ethernet card or adapter configured to support communications between the FMC 202 and the MCDU 208 via an Ethernet cable 229 provided between Ethernet ports 214, 228. In other embodiments, the communications module 226 is configured to support communications between the FMC 202 and the MCDU 208 in accordance with the ARINC 429 (A429) standard via an A429 data bus 229 provided between A429 ports 214, 228 of the respective modules 202, 208. In yet other embodiments, the communications module 226 is configured to support communications between the FMC 202 and the MCDU 208 in accordance with the ARINC 422 (A422) standard via an A422 data bus 229 provided between A422 ports 214, 228 of the respective modules 202, 208. In yet other embodiments, the communications module 226 is configured to support communications between the FMC 202 and the MCDU 208 in accordance with the ARINC 739 (A739) standard via an A739 data bus 229 provided between A739 ports 214, 228 of the respective modules 202, 208.

In various embodiments, the FMC 202 and MCDU 208 communicate using a different communications protocol or standard than one or more of the avionics LRUs 204 and/or the display devices 206. In such embodiments, to support communications of data between the MCDU 208 and those LRUs 204 and/or display devices 206, the data concentrator application 216 at the FMC 202 converts data from one format to another before retransmitting or relaying that data to its destination. For example, the data concentrator application 216 may convert data received from an avionics LRU 204 to the A429 or Ethernet format before providing the data to the MCDU 208, and vice versa. Additionally, in exemplary embodiments, the FMC 202 validates the data received from an avionics LRU 204 before transmitting the data to the MCDU 208. For example, the FMC 202 may perform debouncing, filtering, and range checking, and/or the like prior to converting and retransmitting data from an avionics LRU 204.

It should be noted that although the subject matter may be described herein in the context of the multifunction computing module 208 being realized as an MCDU, in alternative embodiments, the multifunction computing module 208 could be realized as an electronic flight bag (EFB) or other mobile or portable electronic device. In such embodiments, an EFB capable of supporting a FMS application 230 may be connected to an onboard FMC 202 using an Ethernet cable 229 to support flight management functionality from the EFB in an equivalent manner as described herein in the context of the MCDU.

In one or more embodiments, the MCDU 208 stores or otherwise maintains programming instructions, code, or other data for programming the FMC 202 and transmits or otherwise provides the programming instructions to the FMC 202 to update or otherwise modify the FMC 202 to implement the data concentrator application 216. For example, in some embodiments, upon establishment of the connection 229 between modules 202, 208, the MCDU 208 may automatically interact with the FMC 202 and transmit or otherwise provide the programming instructions to the FMC 202, which, in turn, executes the instructions to implement the data concentrator application 216. In some embodiments, the data concentrator application 216 may be implemented in lieu of flight management functionality by the MCDU 208 reprogramming the FMC 202. In other embodiments, the FMC 202 may support the data concentrator application 216 in parallel with flight management functions. In this regard, the FMC 202 may perform flight management functions, while the FMS application 230 on the MCDU 208 supplements the flight management functions to provide upgraded flight management functionality within the aircraft system 200.

A network for managing an aircraft MEL utilizes an MEL that provides real-time aircraft status to crews, maintenance, operations/dispatch centers, and customers with respect to inoperative equipment. The status includes the operational impact and consequences caused by MEL faults. Operators derive the MEL from a certified MMEL that is provided by the OEM. The MMEL accounts for the specific installed equipment, instruments and operational condition of an aircraft. MEL's may have different formats than MMELs, but will never be less restrictive. Once Federal Aviation Administration (FAA) approved, the aircraft MEL becomes the STC (Supplemental Type Certificate), allowing aircraft operation with inoperative equipment.

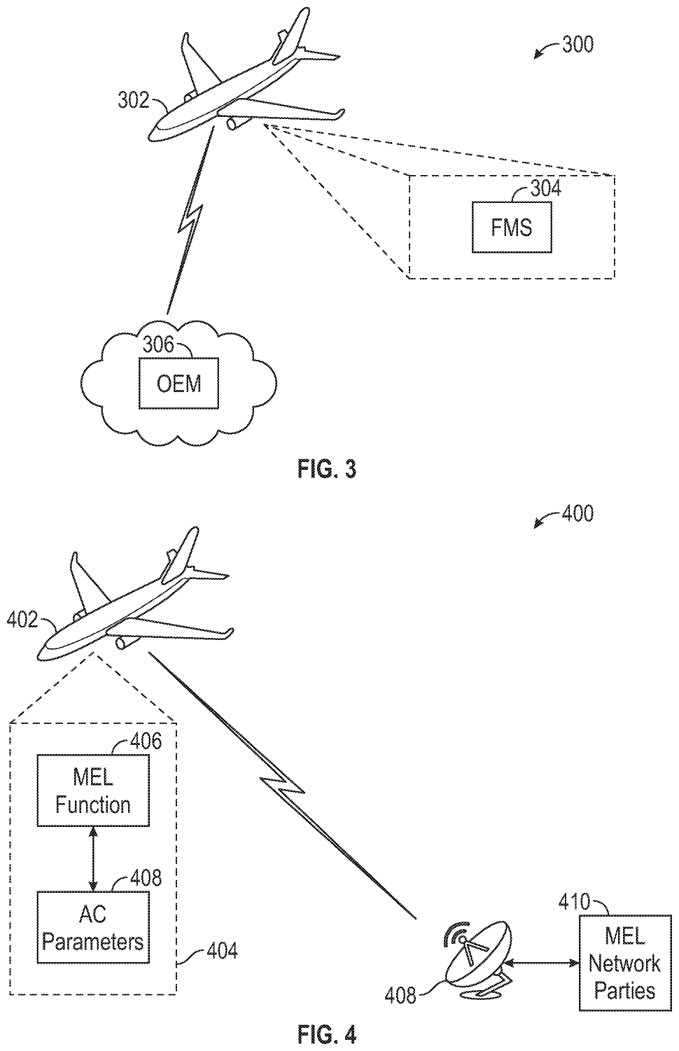

Turning now to FIG. 3, a block diagram 300 is shown of a flight management system (FMS) 304 on board an aircraft 302 that receives and processes the MMEL from the OEM 306. The FMS 304 show here, represents a potential embodiment of the FMS 230 shown previously in FIG. 2. The OEM 306 typically stores the MMEL in a database that is periodically and automatically updated. The database may be ground-based as shown previously in FIG. 1. In other embodiments, the database may be cloud-based. The MMEL is usually uploaded by the FMS prior to preflight operations of the aircraft. The FMS 304 is loaded with an application that derives a specific MEL based on the MMEL for the specific aircraft.

The purpose of an MEL network is to provide an electronic procedures system, which mitigates vulnerabilities and enhances the capabilities of pilots, while reducing crew error and improving the safety and efficiency of operators. The network provides an intelligent procedures system which augments crew task-loading and decision making, in all operational scenarios—Normal, Abnormal, and Emergency—including Reduced Crew and Single-Pilot Operations (SPO). The intended function of the MEL network is to provide a proactive, shared awareness of aircraft fleet status and off-nominal operational impact, while enhancing decision making efficiency, and reducing decision making error with respect to dispatch and continued airworthiness. Use of the network is intended to mitigate problems such as:
delayed departure due to time spent searching for required MEL information that will determine dispatch safety;
cancelled dispatch that is not determined until aircraft preflight and potentially after a flight has already been delayed;
cancelled dispatch due to over-conservative crew judgement;
unsafe dispatch due to crew inexperienced judgement or knowledge;
diverted flights to an airport with unsuitable maintenance capability, resulting in changes to intended destination;
lengthened flights due to course changes that result in increased fuel costs and missed arrival times;
unplanned aircraft downtime due to maintenance or logistical complexities, and waiting for repair of the MEL fault;
an unknown amount of remaining operational time before the aircraft is grounded for maintenance;
Crew Resource Management (CRM) breakdown between crews and maintenance, (i.e., crew notification of faults to maintenance and maintenance to crew); and
increased crew physical and cognitive workload due to increased task load or unfamiliar tasks, forgetting when to perform task modifications, or forgetting the modification entirely.

Turning now to FIG. 4, a block diagram is shown of an MEL network 400. The aircraft 402 has an onboard system 404 that includes an MEL function 406 that monitors aircraft performance parameters 408. The MEL function 406 shown here, is an application that is loaded and executed by the FMS 304 previously shown in FIG. 3. The MEL function 406 communicates 408 the MEL item status to other MEL network parties 410. The MEL network may be onboard, offboard or cloud-based. It typically includes a collection of applications that monitor and update real-time status of aircraft systems that effect the MEL. Onboard applications include the MEL linking function, which connects aircraft digitized MELs with other systems on the flight deck. The MEL linking function processes the required procedural changes and modifies the checklists accordingly. Offboard applications may use cloud-based data input sources. For example, some offboard applications may use personal tablets, smartphones or similar interface devices that provide real-time data from onboard applications. These devices connect with need-to know parties (e.g., aircrews, maintenance, operations, and customers).

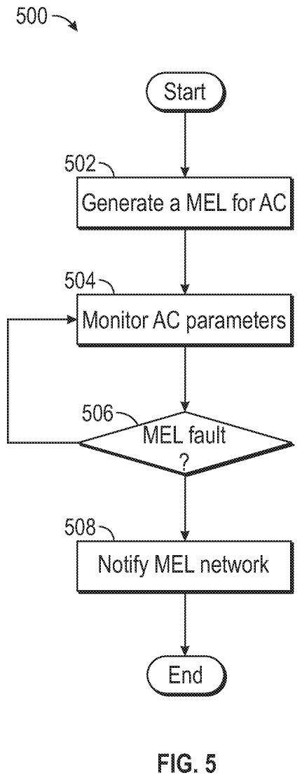

Turning now to FIG. 5, a flow chart is shown of a method of managing an MEL network for an aircraft in accordance with one embodiment. First, the MEL is generated for the specific aircraft 502. The aircraft performance parameters are monitored throughout the aircraft operations 504. The performance parameters are compared to the MEL to determine if an MEL fault is present 506. If a fault is detected, the MEL network is notified. If none is detected, the network continues to monitor the parameters on an ongoing basis. Examples of various MEL faults are shown in Table 1 below including the user, the features, the updates, the methods and the data input locations of the fault.

TABLE 1

| | | Updates | | |
|---|---|---|---|---|
| User | Features (What) | (When) | Methods (How) | Data Input Locations (Where) |
| Crew | Forgetting the modifications | Reminders | Use standard CAS status's and | Flight deck |
| | to procedures (reduce | before and | allow crew to create custom | |
| | workload/remember to | during | (white) CAS messages (notes) | |
| | remember) | required | of MEL reminders and send | |
| | | modified | from EFB to flight deck | |
| | | execution | | |
| Crew | Protect aircraft from | Reminders | CAS message if MEL limit/ | Flight deck |
| | exceeding known limitations | before and | limitation is reached | |
| | | during | | |
| | | required | | |
| | | modified | | |
| | | execution | | |
| Crew | Training video links for | On Demand | Tablet/Mobile Phone | Connected Apps |
| | equipment and tasks that are | | | |
| | normally used or performed, | | | |
| | e.g., EMER radio, SAT | | | |
| | Phone, etc. | | | |
| Crew | MEL search feature/ | On Demand | Visual guide on phone: “This | NGECL + CAS + MEL |
| | interface with CAS Search | | doesn't work”. Visual | |
| | (bi-directional search and | | mapping for pre-flight walk- | |
| | browsing) | | around and interior checks. | |
| | | | Show airplane, allow | |
| | | | touching of section, linked to | |
| | | | a list of items on the aircraft | |
| | | | that in that section. | |
| Crew | Persistent status two clicks | Continuous | associate OEM MEL tags in | NGECL |
| | from MEL state | | checklist tool with MEL IDs a | |
| | | | associated with CAS | |
| | | | messages | |
| Crew | ATC/MX/AOC contact | As required | Tablet/Mobile Phone | Connected Apps |
| | info search feature/ | | | |
| | interface (TechOps?) | | | |
| Crew | to prevent flight operations | As required | proactively provide MEL data | Flight deck + Connected Apps |
| | into unknown conditions | | to crew | |
| Crew | MEL Network Real-Time | As required | Keep aircraft within limitation | Flight deck + Connected Apps |
| | Alerts | | envelopes by modifying | |
| | | | performance tables. Notify all | |
| | | | parties if an operational | |
| | | | impact exists. | |
| Crew | Help overconservative crews | Alerts as | iPhone update with mini- | Onboard Inputs: NGECL and |
| | decide to launch. Enable | they occur. | modified checklist based on | Wi-Fi enabled EFB |
| | legal dispatch when crew is | Before ever | new limitations | (simultaneous transmission with |
| | unsure, (maintain | pre-flighting | | off-board Connected Apps) |
| | operational tempo/flow) | the aircraft | | |
| | | (don't want | | |
| | | to find out | | |
| | | during pre- | | |
| | | flight) | | |
| Crew | Help crews decide if | Alerts as | CAS message if MEL limit/ | Output Source: Flight deck |
| | dispatch is unsafe. Prevent | they occur. | limitation is reached | |
| | illegal dispatch. (use data to | Before ever | | |
| | aid experience/judgement) | pre-flighting | | |
| | | the aircraft | | |
| | | (don't want | | |
| | | to find out | | |
| | | during pre- | | |
| | | flight) | | |
| ALL | How long can we keep | Alerts as | Preview (mobile) limitations | Connected Apps. Complete |
| | flying in with MEL item | they occur | by phase of flight, and before, | system connections between |
| | open? | | and after | MEL, CAS, ECL, EFB, and off- |
| | Mins/Hours/Days/Weeks? | | | board applications. Datalink- |
| | | | | iPad-AOC/OEM/Operator |
| ALL | What does crew need to do | Alerts as | Preview (mobile) limitations | Connected Apps |
| | differently before the flight? | they occur | by phase of flight, and before, | |
| | | | and after | |
| ALL | How will it impact my | Alerts as | Preview (mobile) limitations | Connected Apps |
| | flight? | they occur | by phase of flight, and before, | |
| | | | and after | |
| ALL | All input sources should | Alerts as | Preview (mobile) limitations | Connected Apps |
| | receive same information | they occur | by phase of flight, and before, | |
| | and view same interface | | and after | |
| ALL | Change flight plan routing | Alerts as | Preview (mobile) limitations | Connected Apps |
| | based on new in-air | they occur | by phase of flight, and before, | |
| | limitation | | and after | |
| ALL | Change flight plan routing | Alerts as | Preview (mobile) limitations | Connected Apps |
| | based on known limitations | they occur | by phase of flight, and before, | |
| | (e.g., flight into known icing | | and after | |
| | with icing protection | | | |
| | limitations) at dispatch and | | | |
| | notify all parties | | | |
| ALL | Time before aircraft is | Alerts as | Preview (mobile) limitations | Connected Apps |
| | downed with MEL item | they occur | by phase of flight, and before, | |
| | open (MEL Impact) | | and after | |
| ALL | Goal: improve | Alerts as | Preview (mobile) limitations | Connected Apps |
| | communication between all | they occur | by phase of flight, and before, | |
| | necessary parties (Crew, | | and after | |
| | Mx, Ops, ATC, airline, | | | |
| | customers, passengers, | | | |
| | owners, etc.) | | | |
| ALL | Mitigate CRM breakdown | Alerts as | Preview (mobile) limitations | Offboard Input/Outputs: Internet |
| | with MX before and after | they occur | by phase of flight, and before, | application via external Datalink |
| | flights (MX forgetting to tell | | and after | (simultaneous transmission with |
| | crew limitations and crew | | | on-board application). Distribute |
| | forgetting to report problems | | | from internet application to |
| | found) & (reduce workload/ | | | AOCs, Dispatch, ATC, and MX |
| | remember to remember) | | | Work Centers. |
| ALL | System considers all aspects | Alerts as | Preview (mobile) limitations | System automation (logic) |
| | of MEL item and how it | they occur | by phase of flight, and before, | maximizes interaction with |
| | impacts the flight | | and after | other systems and minimizes |
| | | | | interaction with crew |
| AOC | Provide tail numbers, flight | Alerts as | MEL Network | Connected Apps |
| & | numbers, aircraft type/model | they occur | | |
| MX | | | | |
| AOC | Notify AOC's of change in | Alerts as | MEL Network | Connected Apps |
| & | flight status as necessary | they occur | | |
| MX | | | | |
| Crew | Preview (mobile) types of | Alerts as | Tablet/Mobile Phone | Connected Apps |
| | operations and checklists | they occur | | |
| | effected | | | |
| Crew | Go/No-Go Decision | Alerts as | Tablet/Mobile Phone | Connected Apps |
| | Assistance | they occur | | |
| | (onboard/offboard) | | | |
| Crew | CDLs to modify operational | Alerts as | NGECL feature | Flight deck |
| | tasks w/o modifying | they occur | | |
| | checklists | | | |
| | (“Considerations”) | | | |
| Crew | Remind the crew of | Alerts as | CAS message status | Flight deck |
| | limitations proactively and | they occur | | |
| | in real-time | | | |
| Crew | Protect aircraft from | Alerts as | Show airspeed bugs for MEL | Flight deck |
| | exceeding known limitations | they occur | modified speed limits | |
| Crew | Protect aircraft from | Alerts as | CAS message status + | Flight deck |
| | exceeding known limitations | they occur | performance table protection | |
| | | | limits | |
| Crew | Modified Normal checklists | Alerts as | MEL Logic | Flight deck + Connected Apps |
| | with known inoperable | they occur | | |
| | equipment to meet safe | | | |
| | continued operation or | | | |
| | dispatch | | | |
| Crew | When will expected fault | Alerts as | MEL Logic | Connected Apps |
| & | occur (with time stamp)? | they occur | | |
| MX | | | | |
| Crew | Show modified performance | Alerts as | MEL Logic | Connected Apps |
| & | tables on iPad | they occur | | |
| MX | | | | |
| Crew | Aircraft should produce a | Alerts as | MEL Logic | Connected Apps |
| & | list of all MEL items | they occur | | |
| MX | automatically | | | |
| Crew | Send a/c modified checklists | Alerts as | MEL Logic | Connected Apps |
| & | and status to crew and MX | they occur | | |
| MX | | | | |
| Crew | Placard printing feature for | Alerts as | AirPrint | Printer |
| & | MX and crews | they occur | | |
| MX | | | | |
| MX | Know faults before pre- | Alerts as | If fault occurs on ground, | Connected Apps |
| | flight | they occur | determine if dispatch is | |
| | | | possible and notify | |
| | | | immediately for MX action | |
| | | | and Crew awareness. | |
| MX | MX Delay: Turn reactive in- | Alerts as | If fault occurs in flight, send a | Connected Apps. MX triggers |
| | air faults into proactive MX | they occur | signal to MX to get the | should be logistics connected |
| | triggers (confirm receipt) | | service/part requisition | |
| | | | process started. If fault occurs | |
| | | | on ground, determine if | |
| | | | dispatch is possible and notify | |
| | | | immediately. | |
| MX | Send MEL IDs to MX and | Alerts as | Automatic | Connected Apps |
| & | Ops | they occur | | |
| Ops | | | | |

Present embodiments of the MEL network fill a gap in the dispatch, maintenance, and flight procedures modification process by increasing real-time communication between need-to-know parties when an MEL fault is open. The network notifies the affected parties and provides custom tailored data to each input source on the operational impact of the faults. The data is tailored for intended users, but all data may be available to the entire network. In some embodiments, the MEL network provides updates to mobile/tablet users on flight status to maintenance and operations centers by tail number, flight number, and aircraft type/model. Updates to aircrews may be provided as a phase of flight preview of operations and procedures effected. All updates may be accomplished by digitizing MEL manuals, converting them to a usable database, tagging associated checklist tasks, and then providing the data for processing and procedure modification by an MEL function.

In some embodiments, the most up-to-date MEL information is obtained by automatically and continuously searching for current MEL data, downloading the data from the OEM or Aircraft Operators Certificate (AOC), converting it into the database format with tags, and uploading it to the aircraft MEL function via the MEL network cloud. The MEL function then distributes fault data and modified procedures to the MEL network, notifying the crew by mobile device/tablet of the MEL item, the expected operational impact by phase-of-flight (with expected time stamp), and any checklist impact. The same data is simultaneously visible to maintenance and operations. Additionally, customers are notified of any flight delays.

In other embodiments, crew procedure reminders are paired with checklist modifications, aircraft limitations and consequences, in the form of standard and custom message status options and dialog boxes. The crew may use a custom note which is displayed on the flight deck at the appropriate time as a queue to perform the modified task. The MEL function may analyze performance tables and modify those tables for viewing by the crew and use by aircraft automation systems. In some embodiments, once the MEL fault is identified, it is matched with a modified operational procedure for the aircraft that will compensate for the MEL fault during aircraft operations. A “link” such as a hypertext link is created to the modified operational procedure and displayed to the aircrew either on the flight deck or on a designated mobile device. The link will display the details of the modified procedure to the aircrew along with instructions and analysis of the procedure to compensate for the MEL fault.

In other embodiments, in-flight protection limits are established and reminders are provided to the crew (e.g., MEL airspeed limit) as a result of performance table modifications. Additionally, the MEL function will analyze Consideration Deviation Lists (CDLs), which provide “Considerations” to aircrews on how to further alter procedures without deviating from the written procedures.

In other embodiments, the MEL Network makes it possible to communicate with related aspects of a connected FMS. If an MEL fault opens in flight, the data is automatically transmitted to the MEL network which triggers maintenance action and logistical requisition at the intended destination. If the fault impacts route of flight (e.g., icing protection limits with a route into known icing), the alternate route will be automatically recommended by the MEL function and connected FMS to the crew for consideration. If the destination changes, the MEL network will adjust maintenance/logistics requisition to meet aircraft needs. If the crew has need to communicate with any network party (i.e., ATC, Ops, etc.), contact information can be searched within the MEL function.

Often crews are unable to determine how much operational time remains before the aircraft will require maintenance when an MEL item is open. In some embodiments, the MEL function determines how many days, hours, or minutes remain before the MEL item will cause maintenance down time. This allows the MEL Network to proactively prepare for the maintenance. In turn, this allows crews and customers to avoid unexpected delays by utilizing onboard/offboard, Go/No-Go decision assistance, and real-time status updates. In other scenarios, some equipment and related tasks are used so infrequently (e.g., Emergency Radio, Satellite Phone, etc.) that crews may require instruction. The MEL network provides mobile/tablet links to training videos for crews to accomplish those tasks. Before and after flights, there are often CRM breakdowns. Crews forget to tell maintenance about a fault or maintenance forgets to tell the crew about a fault before a flight. To reduce CRM error, the MEL network is automatically notified of faults and aids the crew and maintenance by providing reminders, keeping all parties informed. To add redundancy, a placard printing feature is available on mobile devices, to allow easy posting of issues in the cockpit as well as modified flight procedures and pre-flight checklists.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A method for managing a minimum equipment list (MEL) for an aircraft, comprising:
generating a MEL that is specific to the aircraft;
monitoring performance parameters of the aircraft;
comparing the performance parameters to the MEL to detect MEL faults, where the performance parameters are continually compared to the MEL during operations of the aircraft; and
notifying a MEL network of the detected MEL faults, where the MEL network comprises parties affected by the detected MEL faults.

2. The method of claim 1, where the MEL is derived from a master minimum equipment list (MMEL) provided by an original equipment manufacturer (OEM) of the aircraft.

3. The method of claim 2, where the MMEL is automatically updated by the OEM and stored in a database.

4. The method of claim 3, where the stored MMEL is uploaded from the database prior to pre-flight operations of the aircraft.

5. The method of claim 1, where the MEL comprises equipment, instruments, and operational conditions of the aircraft.

6. The method of claim 1, where the MEL includes suggested modifications to flight procedures in order to maintain airworthiness of the aircraft upon detecting a MEL fault.

7. The method of claim 6, where the modifications to flight procedures include in-flight parameter protection limits for the aircraft.

8. The method of claim 6, where the modifications to flight procedures include in-flight air crew reminders of the modifications.

9. The method of claim 6, where the modifications to flight procedures are modifications to preflight checklists prior to takeoff of the aircraft.

10. The method of claim 1, where the MEL network is cloud-based.

11. The method of claim 1, where the MEL network is notified in real time of detected MEL faults.

12. The method of claim 1, where the detected MEL faults result in recommended actions provided to a flight management system (FMS) on board the aircraft.

13. The method of claim 1 where the detected MEL faults provide a time limit until mandatory downtime is imposed on the aircraft.

14. The method of claim 1, where the MEL network parties comprise, aircrew, aircraft maintenance personnel, and operations personnel.

15. The method of claim 11, where each MEL network party receives a customized notification of a detected MEL fault, where the customized notification includes task specific information for the MEL network party.

16. The method of claim 1, further comprising:
displaying the MEL faults to an aircrew member on the flight deck of the aircraft.

17. The method of claim 1, further comprising:
matching the MEL fault with a modified flight procedure to compensate for the MEL fault during flight operations of the aircraft;
providing a link to the modified flight procedure; and
displaying the link to an aircrew member of the aircraft.

18. A system for managing a minimum equipment list (MEL) for an aircraft, comprising:
a flight management system (FMS) located on board the aircraft;
a master minimum equipment list (MMEL) that is provided by an original equipment manufacturer (OEM) of the aircraft, where the MMEL is transmitted to the FMS via a data communications link; and
a minimum equipment list (MEL) application loaded on the FMS, where the MEL application,
generates a MEL based on the MMEL that is specific to the aircraft;
monitors performance parameters of the aircraft;
compares the performance parameters to the MEL to detect MEL faults, where the performance parameters are continually compared to the MEL during operations of the aircraft; and
notifies a MEL network of the detected MEL faults, where the MEL network comprises parties affected by the detected MEL faults.
